(19) United States
(12) Patent Application Publication
(10) Pub. No.: US 2016/0219833 A1
(43) Pub. Date: Aug. 4, 2016

(54) ANIMAL GROOMING DEVICE

(71) Applicant: Leagia Estes, Fayetteville, NC (US)

(72) Inventor: Leagia Estes, Fayetteville, NC (US)

(21) Appl. No.: 14/608,700

(22) Filed: Jan. 29, 2015

(51) Int. Cl. A01K 13/00; A47L 7/00

(52) U.S. Cl. CPC A01K 13/00; A47L 7/0085

(57) ABSTRACT

An animal grooming assembly includes a housing structured to resemble an animal. The housing is further structured to have a front section removably coupled to a rear section to access an interior of the housing. A vacuum is positioned within the interior of the housing. The vacuum generates suction. An actuator is coupled to the housing. The actuator is electrically coupled to the vacuum to actuate and de-actuate the vacuum. A hose is coupled to the housing to engage a mammal's fur. The hose is fluidly coupled to the vacuum to suck parasites from the mammal' fur. A brush is coupled to the hose to engage the mammal's fur. Thus, the parasites may be dislodged from the mammal's fur.

### BACKGROUND OF THE DISCLOSURE

### Field of the Disclosure

The disclosure relates to grooming devices and more particularly pertains to a new grooming device for removing parasites from a mammal's fur without utilizing an insecticide.

### SUMMARY OF THE DISCLOSURE

An embodiment of the disclosure meets the needs presented above by generally comprising a housing structured to resemble an animal. The housing is further structured to have a front section removably coupled to a rear section to access an interior of the housing. A vacuum is positioned within the interior of the housing. The vacuum generates suction. An actuator is coupled to the housing. The actuator is electrically coupled to the vacuum to actuate and de-actuate the vacuum. A hose is coupled to the housing to engage a mammal's fur. The hose is fluidly coupled to the vacuum to suck parasites from the mammal' fur. A brush is coupled to the hose to engage the mammal's fur to facilitate dislodging parasites from the mammal's fur.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of an animal grooming assembly according to an embodiment of the disclosure.

FIG. 2 is a left side view of an embodiment of the disclosure.

FIG. 3 is a bottom view of an embodiment of the disclosure.

FIG. 4 is a right side view of an embodiment of the disclosure.

FIG. 5 is a left side view of an embodiment of the disclosure in an open position.

FIG. 6 is an in-use view of an embodiment of the disclosure.

### DESCRIPTION OF THE PREFERRED EMBODIMENT

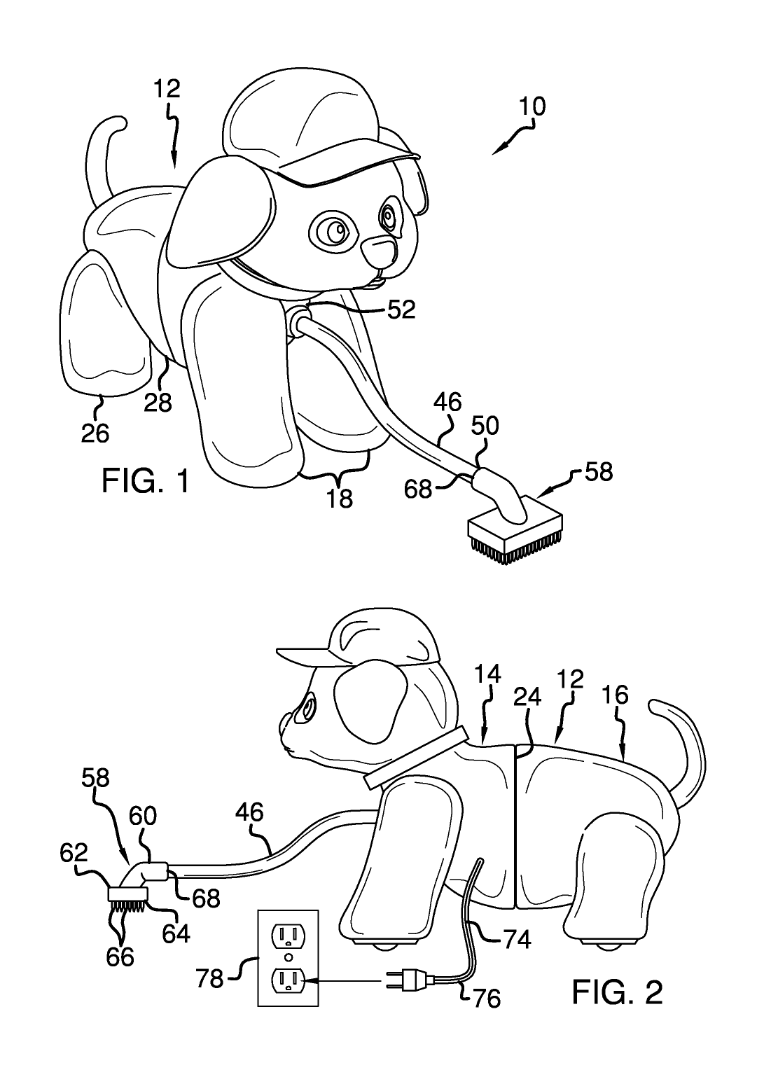

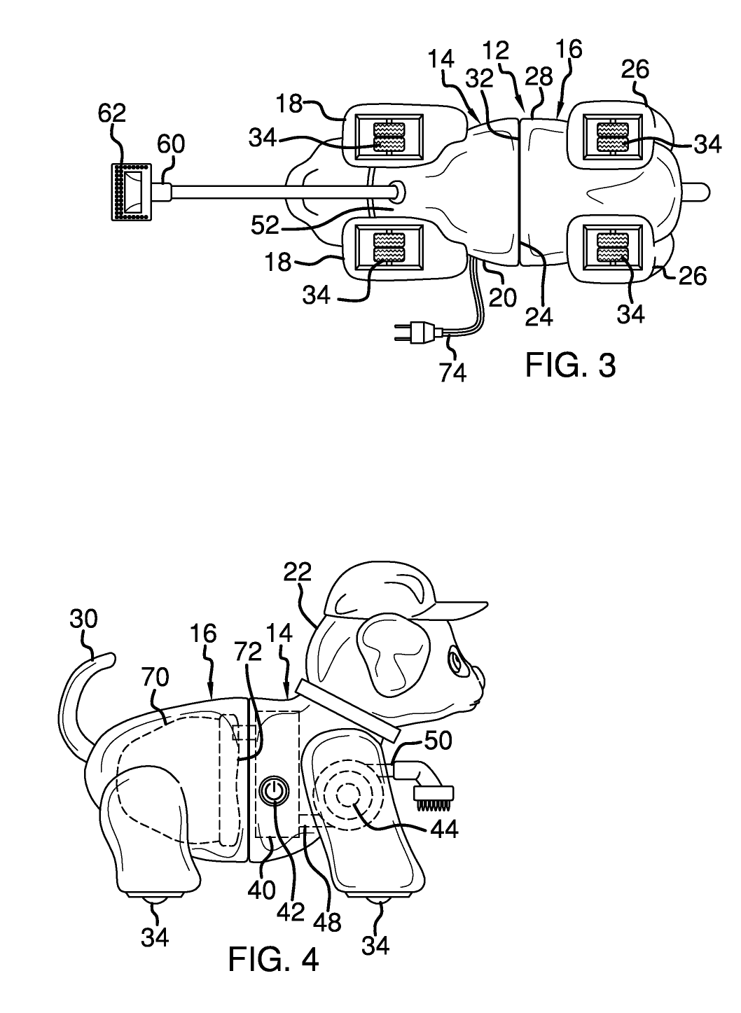

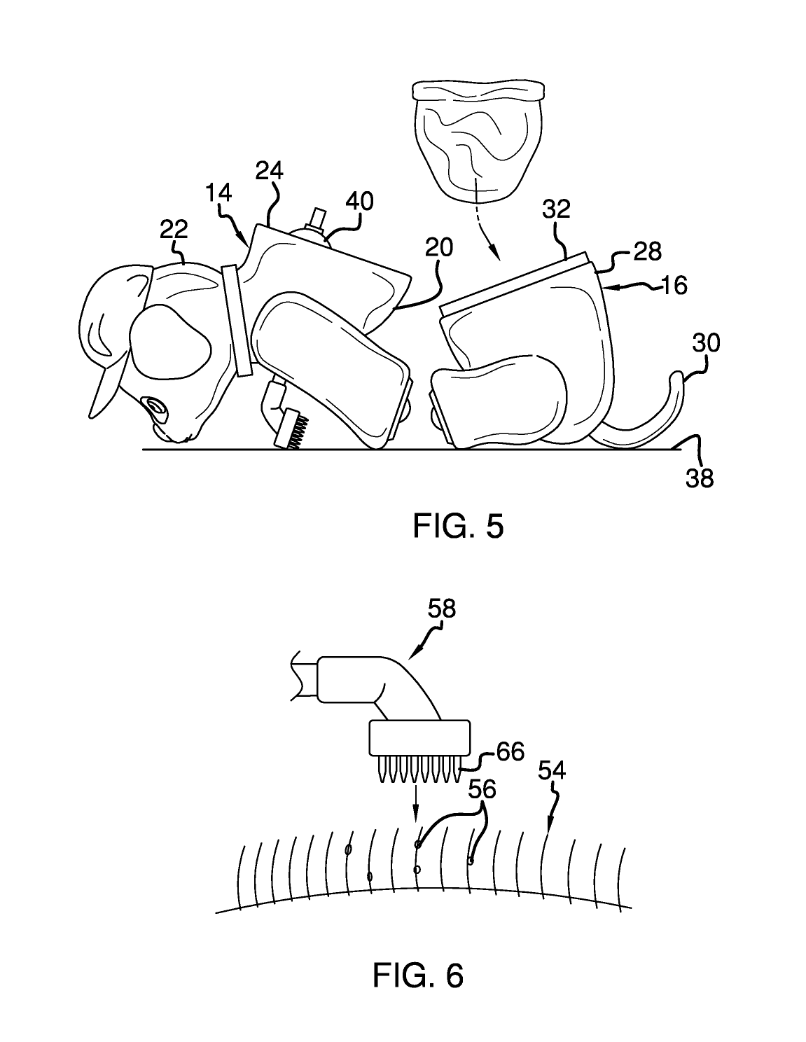

With reference now to the drawings, and in particular to FIGS. 1 through 6 thereof, a new grooming device embodying the principles and concepts of an embodiment of the disclosure and generally designated by the reference numeral 10 will be described.

As best illustrated in FIGS. 1 through 6, the animal grooming assembly 10 generally comprises a housing 12 structured to resemble an animal. The animal may be a dog or the like. The housing 12 resembles the animal to make a mammal comfortable being near the housing 12.

The housing 12 is further structured to have a front section 14 removably coupled to a rear section 16 to access an interior of the housing 12. The front section 14 comprises a pair of front legs of the animal 18. Each of the front legs 18 is coupled to and extends downwardly from opposite sides of a torso of the animal 20. The front section 14 further comprises a head of the animal 22 coupled to and extending upwardly from the torso of the animal 20. The torso of the animal 20 is substantially hollow. A rear end 24 of the torso of the animal 20 is open to access an interior of the front section 14.

The rear section 16 comprises a pair of rear legs of the animal 26. Each of the rear legs 26 is coupled to and extends downwardly from opposite sides of an abdomen of the animal 28. The rear section 16 further comprises a tail of the animal 30 coupled to and extending upwardly from the abdomen 28. The abdomen 28 is substantially hollow. A front end 32 of the abdomen 28 is open to access an interior of the rear section 16. The front end 32 of the abdomen 28 engages the rear end 24 of the torso 20.

A plurality of wheels 34 is provided. Each of the plurality of wheels 34 is rotatably coupled to a lowermost end 36 of an associated one of the pair of front legs 18 and the pair of rear legs 26. The wheels 34 abut a support surface 38 such that the housing 12 is rolled along the support surface 38. The supports surface 38 may be a floor, ground or the like.

A vacuum 40 is positioned within the torso 20. The vacuum 40 is positioned adjacent to the rear end 24. The vacuum 40 generates suction. Moreover, the vacuum 40 may be an electric vacuum or the like. An actuator 42 is coupled to the torso 20. The actuator 42 is electrically coupled to the vacuum 40 to actuate and de-actuate the vacuum 40.

A spool 44 is rotatably positioned within the torso 20. A hose 46 is provided. The hose 46 has a first end 48 and a second end 50. The first end 48 is fluidly coupled to the vacuum 40 such that the hose 46 is wrapped around the spool 44. The second end 50 extends outwardly from a front 52 of the torso 20.

The hose 46 is selectively extended outwardly from the spool 44 such that second end 50 is spaced away from the torso 20 to engage a mammal's fur 54. The mammal may be a dog, cat or other similar house pet. The hose 46 is selectively retracted onto the spool 44 such that the second end 50 is positioned proximate the torso 20. The hose 46 is fluidly coupled to the vacuum 40 to suck parasites 56 from the mammal's fur 54. The parasites 56 may be fleas or the like.

A brush 58 is provided. The brush 58 comprises a tube 60 coupled to and extending upwardly from a body 62 of the brush 58. The body 62 of the brush 58 is substantially hollow. A bottom end 64 of the body 62 is open. A plurality of bristles 66 is coupled to the bottom end 64 of the brush 58. A free end 68 of the tube 66 is coupled to the hose 46. Thus, the bristles 66 may engage the mammal's fur 54 to dislodge the parasites 56 from the mammal's fur 54.

A bag 70 is provided. The bag 70 is positioned within an interior of the abdomen 28. A forward end 72 of the bag 70 is positioned adjacent to the front end 32 of the abdomen 28. The vacuum 40 is fluidly coupled to the forward end 72 of the bag 70 to deliver the parasites 56 into the bag 70. The bag 70 is removable from the abdomen 28 after the bag 70 is filled.

A power supply 74 is coupled to the front section 14. The power supply 74 is electrically coupled to the actuator 42. The power supply 74 comprises a cord 76 extending outwardly from the front section 14. The cord 76 is electrically coupled to a power source 78. The power source 78 may be an electrical outlet or the like.

In use, the mammal's fur 54 is brushed with the bristles 66 when the mammal's fur 54 becomes infested with the parasites 56. The assembly 10 allows the parasites 56 to be removed without the use of insecticides or other toxic chemicals. The bag 70 is removed and disposed of after the parasites 56 are removed from the mammal's fur 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An animal grooming assembly comprising:
a housing structured to resemble an animal, said housing being further structured to have a front section removably coupled to a rear section to access an interior of said housing;
a vacuum positioned within said interior of said housing, said vacuum generating suction;
an actuator coupled to said housing, said actuator being electrically coupled to said vacuum wherein said actuator actuates and de-actuates said vacuum;
a hose coupled to said housing wherein said hose is configured to engage a mammal's fur, said hose being fluidly coupled to said vacuum wherein said hose is configured to suck parasites from the mammal's fur; and
a brush coupled to said hose wherein said brush is configured to engage the mammal's fur to facilitate dislodging parasites from the mammal's fur.

2. The assembly according to claim 1, wherein said front section comprising a pair of front legs of said animal, each of said front legs being coupled to and extending downwardly from a torso of said animal, said front section further comprising a head of said animal coupled to and extending upwardly from said torso of said animal, said torso of said animal being substantially hollow, a rear end of said torso of said animal being open to access an interior of said front section.

3. The assembly according to claim 2, wherein said rear section comprising a pair of rear legs of said animal, each of said rear legs being coupled to and extending downwardly from an abdomen of said animal, said rear section further comprising a tail of said animal coupled to and extending upwardly from said abdomen of said animal, said abdomen of said animal being substantially hollow, a front end of said abdomen of said animal being open to access an interior of said rear section, said front end of said abdomen of said animal engaging said rear end of said torso of said animal.

4. The assembly according to claim 3, wherein said vacuum being positioned within said torso of said animal, said vacuum being positioned adjacent to said rear end.

5. The assembly according to claim 2, further comprising a spool rotatably positioned within said torso of said animal.

6. The assembly according to claim 5, wherein said hose having a first end and a second end, said first end being fluidly coupled to said vacuum such that said hose is wrapped around said spool, said second end extending outwardly from a front of said torso of said animal, said hose being selectively extended outwardly from said spool such that second end is spaced away from said torso of said animal, said hose being selectively retracted onto said spool such that said second end is positioned proximate said torso of said animal.

7. The assembly according to claim 3, further comprising a bag positioned within an interior of said abdomen of said animal, a forward end of said bag being positioned adjacent to said front end, said vacuum being fluidly coupled to said forward end such that said vacuum delivers the parasites into said bag, said bag being removable from said abdomen of said animal after said bag is filled.

8. The assembly according to claim 1, further comprising a power supply coupled to said front section, said power supply being electrically coupled to said actuator, said power supply comprising a cord extending outwardly from said front section, said cord being electrically coupled to a power source.

9. An animal grooming assembly comprising:
a housing structured to resemble an animal, said housing being further structured to have a front section removably coupled to a rear section to access an interior of said housing;
said front section comprising a pair of front legs of said animal, each of said front legs being coupled to and extending downwardly from a torso of said animal, said front section further comprising a head of said animal coupled to and extending upwardly from said torso of said animal, said torso of said animal being substantially hollow, a rear end of said torso of said animal being open to access an interior of said front section;
said rear section comprising a pair of rear legs of said animal, each of said rear legs being coupled to and extending downwardly from an abdomen of said animal, said rear section further comprising a tail of said animal coupled to and extending upwardly from said abdomen of said animal, said abdomen of said animal being substantially hollow, a front end of said abdomen of said animal being open to access an interior of said rear section, said front end of said abdomen of said animal engaging said rear end of said torso of said animal;
a vacuum positioned within said torso of said animal, said vacuum being positioned adjacent to said rear end, said vacuum generating suction;
an actuator coupled to said housing, said actuator being electrically coupled to said vacuum wherein said actuator actuates and de-actuates said vacuum;
a spool rotatably positioned within said torso of said animal;
a hose, said hose having a first end and a second end, said first end being fluidly coupled to said vacuum such that said hose is wrapped around said spool, said second end extending outwardly from a front of said torso of said animal, said hose being selectively extended outwardly from said spool such that second end is spaced away from said torso of said animal wherein said hose is configured to engage a mammal's fur, said hose being selectively retracted onto said spool such that said second end is positioned proximate said torso of said animal, said hose being fluidly coupled to said vacuum wherein said hose is configured to suck parasites from the mammal's fur;
a brush coupled to said hose wherein said brush is configured to engage the mammal's fur to facilitate dislodging parasites from the mammal's fur;
a bag positioned within an interior of said abdomen of said animal, a forward end of said bag being positioned adjacent to said front end of said abdomen of said animal, said vacuum being fluidly coupled to said forward end such that said vacuum delivers the parasites into said bag, said bag being removable from said abdomen of said animal after said bag is filled; and
a power supply coupled to said front section, said power supply being electrically coupled to said actuator, said power supply comprising a cord extending outwardly from said front section, said cord being electrically coupled to a power source.
